(19) United States
(12) Patent Application Publication
(10) Pub. No.: US 2004/0216770 A1
(43) Pub. Date: Nov. 4, 2004

(54) Process for rinsing and drying substrates

(75) Inventors: Pei-Hong Chen, Taoyuan City (TW); Yi-Ping Chen, Sanchung City (TW); Hong-San Lan, Nantou City (TW); Yi-Ling Chen, Taichung (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/426,548

(22) Filed: Apr. 29, 2003

(51) Int. Cl. B08B 7/04; B08B 3/00

(52) U.S. Cl. 134/30; 134/34; 134/37; 134/26

(57) ABSTRACT

A new and improved process for rinsing and drying a wafer to remove photoresist stripping chemicals and residue from the wafer during a photoresist stripping operation. The rinsing and drying process includes dispensing a heated rinsing liquid onto the wafer followed by application of a heated drying gas against the wafer to dry the rinsing liquid from the wafer. Heating of the rinsing liquid and drying gas facilitates expedited rinsing and drying, respectively, of the wafer, resulting in increased wafer throughput and enhanced efficiency of the photoresist stripping process.

### FIELD OF THE INVENTION

The present invention relates to processes used in the fabrication of integrated circuits (ICs) on semiconductor wafer substrates. More particularly, the present invention relates to a process for rinsing and drying wafers by dispensing hot rinsing liquid and drying gas, respectively, onto the wafer to reduce the time required for the wafer rinsing and drying steps, such as during a photoresist stripping process, for example.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

Photoresist materials are coated onto the surface of a wafer by dispensing a photoresist fluid typically on the center of the wafer as the wafer rotates at high speeds within a stationary bowl or coater cup. The coater cup catches excess fluids and particles ejected from the rotating wafer during application of the photoresist. The photoresist fluid dispensed onto the center of the wafer is spread outwardly toward the edges of the wafer by surface tension generated by the centrifugal force of the rotating wafer. This facilitates uniform application of the liquid photoresist on the entire surface of the wafer.

During the photolithography step of semiconductor production, light energy is applied through a reticle mask onto the photoresist material previously deposited on the wafer to define circuit patterns which will be etched in a subsequent processing step to define the circuits on the wafer. A reticle is a transparent plate patterned with a circuit image to be formed in the photoresist coating on the wafer. A reticle contains the circuit pattern image for only a few of the die on a wafer, such as four die, for example, and thus, must be stepped and repeated across the entire surface of the wafer. In contrast, a photomask, or mask, includes the circuit pattern image for all of the die on a wafer and requires only one exposure to transfer the circuit pattern image for all of the dies to the wafer.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Spin coating of photoresist on wafers, as well as the other steps in the photolithography process, is carried out in an automated coater/developer track system using wafer handling equipment which transport the wafers between the various photolithography operation stations, such as vapor prime resist spin coat, develop, baking and chilling stations. Robotic handling of the wafers minimizes particle generation and wafer damage. Automated wafer tracks enable various processing operations to be carried out simultaneously. Two types of automated track systems widely used in the industry are the TEL (Tokyo Electron Limited) track and the SVG (Silicon Valley Group) track.

A typical method of forming a circuit pattern on a wafer includes introducing the wafer into the automated track system and then spin-coating a photoresist layer onto the wafer. The photoresist is next cured by conducting a soft bake process. After it is cooled, the wafer is placed in an exposure apparatus, such as a stepper, which aligns the wafer with an array of die patterns etched on the typically chrome-coated quartz reticle. When properly aligned and focused, the stepper exposes a small area of the wafer, then shifts or “steps” to the next field and repeats the process until the entire wafer surface has been exposed to the die patterns on the reticle. The photoresist is exposed to light through the reticle in the circuit image pattern. Exposure of the photoresist to this image pattern cross-links and hardens the resist in the circuit pattern. After the aligning and exposing step, the wafer is exposed to post-exposure baking and then is developed and hard-baked to develop the photoresist pattern.

The circuit pattern defined by the developed and hardened photoresist is next transferred to the underlying metal conductive layer using a metal etching process, in which metal over the entire surface of the wafer and not covered by the cross-linked photoresist is etched away from the wafer with the metal under the cross-linked photoresist that defines the circuit pattern protected from the etchant. As a result, a well-defined pattern of metallic microelectronic circuits which closely approximates the cross-linked photoresist circuit pattern remains in the metal layer.

After the circuit pattern is etched in the metal layer, residual photoresist remains on the wafer. During the metal etch process, some of the photoresist residue becomes sputtered from the wafer and redeposited onto the side walls of the metal circuit structures. Additionally, some of the photoresist reacts with etch reactants and products to form polymeric residue. These photoresist residues must be removed from the wafer prior to completing the IC fabrication process.

Typically, the wafer is subjected to a two-step process for removal of the photoresist reactants and residue from the wafer. The first step in the process is an oxygen plasma (plasma ashing) step which removes most or all of the unreacted residual photoresist from the wafer. The second step is a wet strip process which is used to remove the polymeric residue from the wafer. During the oxygen plasma step, the unreacted residual photoresist reacts with the oxygen to form volatile compounds which leave the wafer surface. However, the gases present in the oxygen plasma tend to react with and harden some of the residual photoresist, which remains on the wafer. In the subsequent wet strip step, a solvent solution is used to remove the hardened residual photoresist generated during the oxygen plasma step, as well as the polymeric residue formed from the photoresist during the metal etch process, from the wafer and circuit structures.

In a typical spin-type photoresist wet stripping operation, a wafer is supported on a rotating wafer support in a PRS (photoresist stripping) chamber such as that available from the SEZ corporation of Phoenix, Ariz. As the wafer is rotated by the wafer support, a liquid strip chemical, which is an organic solvent, is dispensed onto the upper surface of the wafer, typically at the center thereof. The strip chemical spreads outwardly over the surface of the wafer due to the centrifugal force exerted on the strip chemical by the spinning wafer. The strip chemical removes residual photoresist (not shown) from the surface of the wafer, including circuit lines etched in the conductive layer on the wafer in a previous metal etch process, prior to continued fabrication of integrated circuits on the wafer. After the strip chemical removes the residual photoresist from the surface of the wafer, the strip chemical and any remaining photoresist residue must be removed from the wafer as well. This is accomplished by first rinsing the wafer with a rinsing liquid such as DIW (deionized water), followed by drying of the wafer using an inert drying gas such as nitrogen.

A typical wet stripping recipe includes 8 steps, including the actual stripping of the photoresist from the wafer and the subsequent wafer rinsing and drying steps. The 8 steps typically require about 230 seconds from start to completion of these 8 steps, the wafer rinsing and drying process may include 4 steps and require about 100 seconds from start to completion. Thus, the wafer rinsing and drying process consumes typically about 43.5% of the time required to carry out the process recipe for the photoresist stripping operation.

During the conventional wafer-rinsing and drying process, both the rinsing liquid and the drying gas are typically at room temperature (about 25 degrees C.) when applied to the wafer. It has been found that heating the rinsing liquid and drying gas prior to dispensing these onto the wafer surface expedites both the wafer rinsing and the wafer drying step of the photoresist stripping process, thereby reducing the total time required for carrying out the process recipe from about 230 seconds to about 180 seconds. This translates into an improvement in wafer throughput of about 28% (from about 27 wafers per hour per chamber to about 35 wafers per hour per processing chamber).

Accordingly, an object of the present invention is to provide a new and improved process which is suitable for rinsing and drying substrates in a variety of applications.

Another object of the present invention is to provide a new and improved process which is suitable for rinsing and drying wafers during a photoresist strip process.

Another object of the present invention is to provide a wafer rinsing and drying process which enhances wafer throughput.

Still another object of the present invention is to provide a wafer rinsing and drying process which enhances efficiency of a photoresist stripping or other process.

Yet another object of the present invention is to provide a new and improved wafer rinsing and drying process which includes applying a heated rinsing liquid to a wafer after a photoresist stripping or other process.

A still further object of the present invention is to provide a new and improved wafer rinsing and drying process which includes applying a heated drying gas to a wafer after the wafer is rinsed.

Yet another object of the present invention is to provide a new and improved wafer rinsing and drying process which includes applying a heated rinsing liquid to a wafer to remove photoresist stripping or other residues and stripping or other liquid from the wafer, followed by applying a heated drying gas to the wafer after the rinsing step to dry the wafer.

### SUMMARY OF THE INVENTION

In accordance with these and other objects and advantages, the present invention is generally directed to a new and improved process for rinsing and drying a wafer to remove photoresist stripping chemicals and residue or other chemicals and/or residue from the wafer during a photoresist stripping operation. The rinsing and drying process typically includes dispensing a heated rinsing liquid onto the wafer followed by application of a heated drying gas against the wafer to dry the rinsing liquid from the wafer. Heating of the rinsing liquid and drying gas facilitates expedited rinsing and drying, respectively, of the wafer, resulting in increased wafer throughput and enhanced efficiency of the photoresist stripping or other process.

In a typical embodiment, the rinsing liquid is DIW (deionized water) and the drying gas is molecular nitrogen (N₂) The DIW is typically heated to a temperature of about 40 degrees C prior to being dispensed on the wafer, whereas the drying gas is typically heated to a temperature of from about 40 degrees Celsius to about 60 degrees Celsius prior to being dispensed against the wafer after the wafer is rinsed.

### BRIEF DESCRIPTION OF THE DRAWINGS

The invention will now be described, by way of example, with reference to the accompanying drawings, in which:

FIG. 1 is a schematic view of a conduit system for a photoresist stripping apparatus suitable for implementation of the process of the present invention;

FIG. 2 is a schematic view of a heated liquid/gas dispensing system for use in implementation of the process of the present invention, dispensing heated rinsing liquid and heated drying gas, respectively, onto a wafer according to the process of the present invention; and

FIG. 3 is a flow diagram illustrating sequential implementation of the various processing steps according to the process of the present invention.

### DESCRIPTION OF THE PREFERRED EMBODIMENTS

The present invention is generally applicable to rinsing photoresist stripping chemicals and residues from semiconductor wafer substrates during a photoresist (PR) stripping process used in the fabrication of integrated circuits on the substrates. However, it is understood that the present invention may be applicable to rinsing and drying substrates at various other stages during semiconductor processing, as well as rinsing and drying of substrates in other industrial applications.

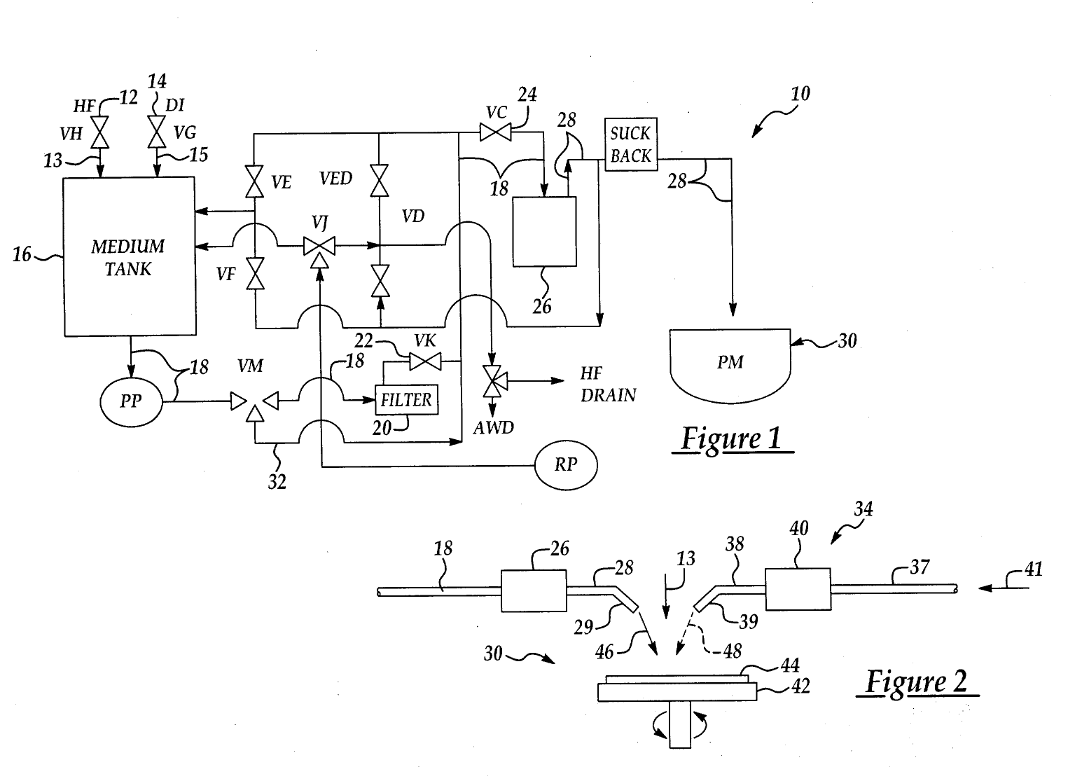

A schematic view of a processing liquid distribution system suitable for implementation of the present invention is generally indicated by reference numeral 10 in FIG. 1. The particular system 10 shown in FIG. 1 is used to distribute a photoresist stripping chemical 13 from a tank 16 to a processing module or chamber 30 in a SEZ photoresist stripping system available from the SEZ corporation of Phoenix, Ariz. However, it is understood that the process of the present invention is not limited to the particular processing liquid distribution system 10 illustrated in FIG. 1, but may be equally applicable and adapted to systems of alternative design and purpose.

The processing liquid distribution system 10 includes a strip chemical valve 12 through which HF (hydrogen fluoride) or other photoresist stripping chemical 13 is introduced into the tank 16, as well as a rinsing liquid valve 14 through which DIW (deionized water) or other rinsing liquid 15 is introduced into the tank 16. An outlet conduit 18 leads from the tank 16, through a filter 20 and a filter exit valve 22, respectively. A filter bypass conduit 32 may bypass the filter 20 and the filter exit valve 22. In accordance with the present invention, a liquid heater 26 is provided between the downstream end of the outlet conduit 18 and the upstream end of a heated liquid dispensing conduit 28 which leads from the liquid heater 26 and communicates with the processing module or chamber 30 of the system 10. A heater entry valve 24 may be provided in the outlet conduit 18, adjacent to the liquid heater 26.

A liquid/gas heating and dispensing system suitable for carrying out the process of the present invention is generally indicated by reference numeral 34 in FIG. 2. The liquid/gas heating and dispensing system 34 includes the liquid heater 26 which is provided between the outlet conduit 18 and the heated liquid dispensing conduit 28 of the processing liquid distribution system 10, as heretofore described with respect to FIG. 1. The liquid/gas heating and dispensing system 34 further includes a gas heater 40 which is provided between a gas distribution conduit 37 that receives a supply of drying gas from a gas source (not shown), and a heated gas dispensing conduit 38. A liquid dispensing nozzle 29 of the heated liquid dispensing conduit 28, as well as a gas dispensing nozzle 39 of the heated gas dispensing conduit 38, are disposed above a typically rotatable wafer support 42 which supports a wafer 44 inside the process module or chamber 30, as hereinafter described.

Referring next to FIGS. 1-3, in typical application the process of the present invention is effective in the expedited rinsing and drying of a semiconductor wafer 44 after a photoresist stripping process is carried out on the wafer 44. Such expedited rinsing and drying of the wafer increases the throughput of successive wafers in the photoresist stripping operation, contributing to enhanced operational efficiency in semiconductor processing. Accordingly, as shown in FIG. 1, the photoresist stripping operation is initially carried out as follows. A photoresist stripping chemical 13, having been distributed from the tank 16 of the processing liquid distribution system 10 to the processing module or chamber 30 in conventional fashion, is dispensed onto the wafer 44 as the wafer 44 is rotated at a selected speed, as shown in FIG. 2. The strip chemical 13 is dispensed typically onto the center of the wafer 44 and spreads outwardly over the surface of the wafer 44 due to the centrifugal force exerted on the strip chemical 13 by the spinning wafer 44. The strip chemical 13 removes residual photoresist (not shown) from the surface of the wafer 44, including circuit lines etched in the conductive layer on the wafer 44 in a previous metal etch process, for example.

After the strip chemical 13 removes the residual photoresist from the surface of the wafer 44, the strip chemical 13 and any loose or dislodged photoresist residue remaining on the wafer 44 must be removed therefrom as well. According to the process of the present invention, this is accomplished by first rinsing the wafer 44 with a heated rinsing liquid 46 such as DIW (deionized water), followed by drying of the wafer 44 using a hot inert drying gas 48 such as molecular nitrogen (N₂). Accordingly, the rinsing liquid 15, which is typically initially maintained at room temperature (about 25 degrees Celsius), is initially distributed from the tank 16 to the liquid heater 26 through the outlet conduit 18 of the processing liquid distribution system 10. The liquid heater 26 heats the rinsing liquid 15 from about 25 degrees Celsius to an elevated temperature, for example, to about 40 degrees Celsius. Next, the heated rinsing liquid 46 is distributed from the liquid heater 26, through the heated liquid conduit 28 and liquid dispensing nozzle 29, respectively, and dispensed onto the wafer 44 as the wafer 44 is rotated at a selected speed, for example about 1000-2000rpm, for typically about 20-30 seconds. As it is drawn by centrifugal force across the surface of the spinning wafer 44, the heated rinsing liquid 46 rinses the wafer 44 and removes loose photoresist and residual strip chemical 13 from the wafer 44, as is known by those skilled in the art.

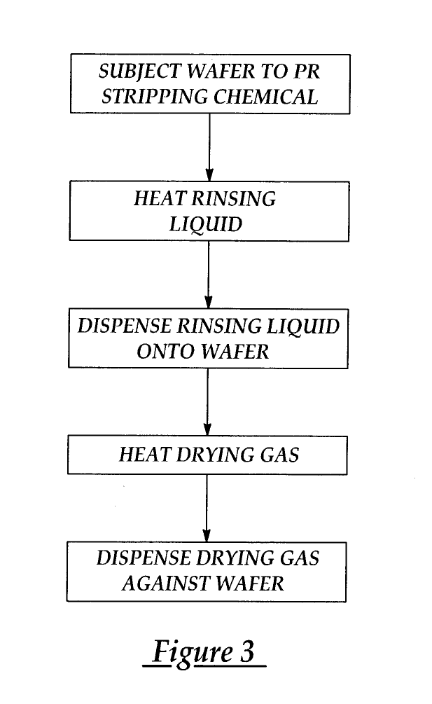

Before the heated rinsing liquid 46 is dispensed onto the rotating wafer 44, a supply of the drying gas 41, typically maintained at room temperature (about 25 degrees Celsius), is distributed from a gas source (not shown), through the gas distribution conduit 37 to the gas heater 40. The initially room temperature drying gas 41 is heated in the gas heater 40 to an elevated temperature, for example, about 40-60 degrees Celsius. After the rinsing step is completed, and as the wafer 44 is typically rotated by the wafer support 42 at speeds of typically about 1000-2000 rpm, the heated drying gas 48 is dispensed from the gas heater 40, through the heated gas conduit 38 and gas dispensing nozzle 39, respectively, and against the wafer 44 to dry the wafer 44, typically for a period of about 20-30 seconds. This step thoroughly dries the heated rinsing liquid 46 previously dispensed onto the wafer 44, from the wafer 44. The heating, rinsing and dispensing steps of the present invention are summarized in FIG. 3.

It will be appreciated by those skilled in the art that the combined steps of sequentially rinsing and drying the wafer 44 using the heated rinsing liquid 46 and the heated drying gas 48, respectively, in accordance with the process of the present invention is typically about 50 seconds, whereas the conventional rinsing and drying process requires about 100 seconds for thorough rinsing and drying of the wafer. This results in a time savings of about 50 seconds for the PR stripping operation of each wafer, increasing wafer throughput by about 43.5%.

While the preferred embodiments of the invention have been described above, it will be recognized and understood that various modifications can be made in the invention and the appended claims are intended to cover all such modifications which may fall within the spirit and scope of the invention.

What is claimed is:

1. A process for rinsing and drying a substrate, comprising the steps of:
providing a rinsing liquid;
heating said rinsing liquid to a liquid temperature above about 25 degrees Celsius
dispensing said rinsing liquid onto the substrate;
providing a drying gas; and
dispensing said drying gas against the substrate.

2. The process of claim 1 wherein said rinsing liquid comprises deionized water.

3. The process of claim 1 wherein said liquid temperature is at least about 40 degrees Celsius.

4. The process of claim 3 wherein said rinsing liquid comprises deionized water.

5. The process of claim 1 wherein said drying gas comprises nitrogen.

6. The process of claim 5 wherein said rinsing liquid comprises deionized water.

7. The process of claim 5 wherein said liquid temperature is at least about 40 degrees Celsius.

8. The process of claim 7 wherein said rinsing liquid comprises deionized water.

9. A process for rinsing and drying a substrate, comprising the steps of:
providing a rinsing liquid;
heating said rinsing liquid to a liquid temperature above about 25 degrees Celsius;
dispensing said rinsing liquid onto the substrate;
providing a drying gas;
heating said drying gas to a gas temperature above about 25 degrees Celsius; and
dispensing said drying gas against the substrate.

10. The process of claim 9 wherein said rinsing liquid comprises deionized water.

11. The process of claim 9 wherein said liquid temperature is about degrees Celsius.

12. The process of claim 9 wherein said drying gas comprises nitrogen.

13. The process of claim 9 wherein said gas temperature is from at least about 40 degrees Celsius to about 60 degrees Celsius.

14. The process of claim 13 wherein said rinsing liquid comprises deionized water.

15. The process of claim 13 wherein said liquid temperature is at least about 40 degrees Celsius.

16. The process of claim 13 wherein said drying gas comprises nitrogen.

17. A process for rinsing and drying a substrate, comprising the steps of:
providing a rinsing liquid;
dispensing said rinsing liquid onto the substrate;
providing a drying gas;
heating said drying gas to a gas temperature above about 25 degrees Celsius; and
dispensing said drying gas against the substrate.

18. The process of claim 17 wherein said rinsing liquid comprises deionized water.

19. The process of claim 17 wherein said drying gas comprises nitrogen and said gas temperature is about 40 degrees Celsius.

20. The process of claim 17 further comprising the step of heating said rinsing liquid to a rinsing liquid temperature of at least about 40 degrees Celsius prior to said dispensing said rinsing liquid onto the substrate.
